(19) United States
(12) Patent Application Publication
(10) Pub. No.: US 2019/0135303 A1
(43) Pub. Date: May 9, 2019

(54) CLOUD SERVER FOR PROVIDING DRIVER-CUSTOMIZED SERVICE BASED ON CLOUD, OPERATING SYSTEM INCLUDING THE CLOUD SERVER, AND OPERATING METHOD THEREOF

(71) Applicant: Electronics and Telecommunications Research Institute, Daejeon (KR)

(72) Inventors: Whui KIM, Ulsan (KR); Jin Kyu CHOI, Daejeon (KR); Sung Woong SHIN, Daejeon (KR); Hyun Kyun CHOI, Ulsan (KR)

(73) Assignee: Electronics and Telecommunications Research Institute, Daejeon (KR)

(21) Appl. No.: 16/182,187

(22) Filed: Nov. 6, 2018

(30) Foreign Application Priority Data
Nov. 7, 2017 (KR) 10-2017-0147081
Nov. 6, 2018 (KR) 10-2018-0134971

(51) Int. Cl. B60W 50/08; B60W 50/14; G06N 99/00

(52) U.S. Cl. CPC B60W 50/085; B60W 2050/0077; G06N 99/005; B60W 50/14

(57) ABSTRACT

A digital cockpit system communicates with a cloud server and outputs an output result of a vehicle's internal system according to a human-machine interface (HMI) output policy optimized for a personal driving tendency of a personal driver by using a driver-customized parameter received from the cloud server.

### CROSS-REFERENCE TO RELATED APPLICATIONS

This application claims priority under 35 U.S.C. § 119 to Korean Patent Application No. 10-2017-0147081, filed on Nov. 7, 2017 and Korean Patent Application No. 10-2018-0134971, filed on Nov. 6, 2018, the disclosure of which is incorporated herein by reference in its entirety.

### TECHNICAL FIELD

The present invention relates to a digital cockpit platform for providing a driver-customized service based on a cloud.

### BACKGROUND

As well known, an intelligent driver assistance system equipped in vehicles is a system which has been developed for providing various services for the convenience and safety of drivers.

A driver assistance system, which is being currently released, provides a generalized driver assistance system without considering the driving tendency of a driver. For this reason, the satisfactions of drivers in a safety and convenience system differ depending on the driving tendencies of the drivers. In addition, there is a difficulty in that a driver should visit a service center for upgrading and updating for improving a function and performance.

### SUMMARY

Accordingly, the present invention provides a cloud server, an operating system including the cloud server, and an operating method thereof, which update a vehicle's internal system such as a driving assistance system on the basis of the driving tendency of a driver without visiting a service center.

In one general aspect, a cloud server for communicating with a vehicle, including a driver assistance system for providing driving assistance information associated with safety of a driver and a digital cockpit system for providing the driving assistance information in cooperation with the driver assistance system, includes a processor module and a communication module configured to communicate with the digital cockpit system, wherein, in order to customize the driving assistance information for a personal driving tendency of a personal driver, the processor module collects personal vehicle information about the personal driver from the digital cockpit system through the communication module, determines the personal driving tendency based on the collected personal vehicle information by using a previously built machine learning model, generates a driver-customized parameter based on the determined personal driving tendency, and transmits the driver-customized parameter to the digital cockpit system through the communication module so that the digital cockpit system applies the driver-customized parameter to an output policy corresponding to the driving assistance information.

In another general aspect, an operating system includes a digital cockpit system configured to receive driving assistance information associated with safety and convenience of a personal driver from a driver assistance system over an internal communication network of a vehicle, output the driving assistance information according to a human-machine interface (HMI)-based output policy (hereinafter referred to as an HMI output policy), and collect personal vehicle information about the personal driver from a plurality of vehicle sensors over the internal communication network of the vehicle; and a cloud server configured to collect the personal vehicle information from the digital cockpit system over a wireless network for customizing the driving assistance information for a personal driving tendency of the personal driver, predict a driver-customized parameter based on the collected personal vehicle information by using a previously built machine learning model, and transmit the driver-customized parameter to the digital cockpit system over the wireless network, wherein the digital cockpit system applies the driver-customized parameter to the HMI output policy.

In another general aspect, an operating method of an operating system, including a cloud server and a digital cockpit system connected to a driver assistance system, includes: collecting, by the digital cockpit system, personal vehicle information including pieces of driving information received from sensors of a vehicle; transmitting, by the cloud server, a request message requesting the personal vehicle information to the digital cockpit system; transmitting, by the digital cockpit system, the personal vehicle information to the cloud server in response to the request message; determining, by the cloud server, a personal driving tendency corresponding to the personal vehicle information by using a machine learning model, generating a driver-customized parameter based on the determined personal driving tendency, and transmitting the driver-customized parameter to the digital cockpit system; and applying, by the digital cockpit system, the driver-customized parameter received from the cloud server to an output policy corresponding to driving assistance information received from the driver assistance system.

Other features and aspects will be apparent from the following detailed description, the drawings, and the claims.

### BRIEF DESCRIPTION OF THE DRAWINGS

FIG. 1 is a block diagram illustrating an operating system according to an embodiment of the present invention.

FIG. 2 is a block diagram schematically illustrating an internal configuration of a digital cockpit system according to an embodiment of the present invention.

FIG. 3 is a diagram for describing an example of an output policy of the digital cockpit system illustrated in FIG. 2.

FIG. 4 is a diagram for describing another example of an output policy of the digital cockpit system illustrated in FIG. 2.

FIG. 5 is a block diagram schematically illustrating an internal configuration of a cloud server according to an embodiment of the present invention.

FIG. 6 is a block diagram illustrating an operating system according to another embodiment of the present invention.

FIG. 7 is a block diagram schematically illustrating an internal configuration of a local server according to an embodiment of the present invention.

FIG. 8 is a flowchart illustrating an operating method of an operating system according to an embodiment of the present invention.

FIGS. 9A and 9B are a flowchart illustrating an operating method of an operating system according to another embodiment of the present invention.

### DETAILED DESCRIPTION OF EMBODIMENTS

Hereinafter, embodiments of the present invention will be described in detail with reference to the accompanying drawings. Reference will now be made in detail to embodiments, examples of which are illustrated in the accompanying drawings. In this regard, the present embodiments may have different forms and should not be construed as being limited to the descriptions set forth herein. Also, numerous modifications and adaptations will be readily apparent to those of ordinary skill in the art without departing from the spirit and scope of the present invention.

It will be further understood that the terms “comprises” “comprising,” “includes” and/or “including” when used herein, specify the presence of stated features, integers, steps, operations, elements, and/or components, but do not preclude the presence or addition of one or more other features, steps, operations, elements, components, and/or groups thereof. Moreover, each of terms such as “ . . . unit”, “ . . . apparatus” and “module” described in specification denotes an element for performing at least one function or operation, and may be implemented in hardware, software or the combination of hardware and software.

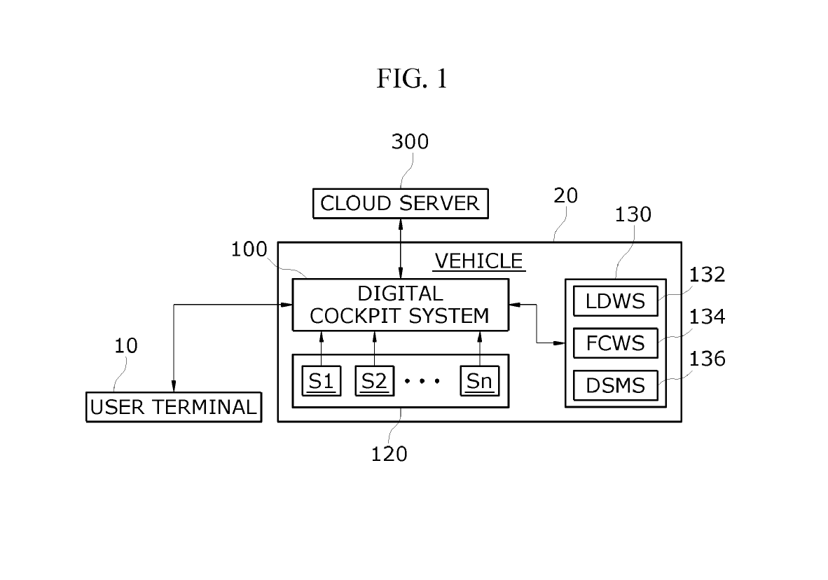

FIG. 1 is a block diagram illustrating an operating system according to an embodiment of the present invention.

Referring to FIG. 1, the operating system according to an embodiment of the present invention may include a digital cockpit system 100 and a cloud server 300 which communicates with the digital cockpit system 100.

The digital cockpit system 100 may be equipped in various vehicles 20 such as cars, commercial vehicles, vans, rental cars, and car-sharing vehicles.

The digital cockpit system 100 may be a system for supporting a human-machine interface (HMI) where a function of a vehicle 20 and significant information about the vehicle 20 are controlled and managed by using a center screen.

The digital cockpit system 100 may collect various pieces of driving information from a sensor group 120 including a plurality of vehicle sensors Si to Sn (where n is an integer equal to or more than two) and may receive pieces of driving assistance information from a vehicle's internal system such as an advanced driver assistance system 130.

The vehicle sensors S1 to Sn may include, for example, a fuel pressure sensor (FPS), an acceleration position sensor (APS), a brake pedal sensor (BPS), a distance sensor (for example, an ultrasonic sensor, a radar, or the like), a camera (for example, a color camera, a stereo camera, or the like), a navigation device, and a temperature/humidity sensor for controlling an air volume of an air conditioner.

Pieces of information collected from the vehicle sensors S1 to Sn may include, for example, the amount of sprayed fuel measured by the FPS, an acceleration pedal value measured by the APS, a pedal pressure value measured by the brake pedal sensor, a distance value to a peripheral obstacle measured by the distance sensor, a driver face image captured by the camera, an internal temperature/humidity value of a vehicle measured by the temperature/humidity sensor, information about a global positioning system (GPS) sensor, information about a sensor (for example, a gyro sensor, an acceleration sensor, or the like) for measuring a posture of a vehicle, and information about a vehicle velocity sensor.

The pieces of information collected from the vehicle sensors S1 to Sn may each be used as information for analyzing the personal driving tendency of a personal driver.

The advanced driver assistance system 130 may include, for example, at least one of a lane departure warning system (LDWS) 132, a forward collision warning system (FCWS) 134, and a driver status monitoring system (DSMS) 136. Although not shown, the advanced driver assistance system 130 may further include an adaptive cruise control (ACC). The LDWS 132 may be referred to as a lane keeping assistance system (LKAS). In an embodiment of the present invention, the systems 132, 134, and 136 are limited, and thus, their descriptions are omitted.

Driving assistance information obtained from the advanced driver assistance system 130 may include, for example, at least one of lane departure warning information received from the LDWS 132, forward vehicle collision warning information received from the FCWS 134, and drowsy driving warning information received from the DSMS 136.

Each of the pieces of information may include an identification (ID) representing the kind of a driving assistance service and a real status value representing a real driving status of the vehicle 20.

An ID included in the lane departure warning information may be an ID which issues a command to warn against lane departure, an ID included in the forward vehicle collision warning information may be an ID which issues a command to warn against forward vehicle collision, and an ID included in drowsy driving warning information may be an ID which issues a command to warn against driving while drowsy.

A real status value included in the lane departure warning information may be a real distance value between a lane mark line and the vehicle 20 which is currently driving, and a real status value included in the forward vehicle collision warning information may be a real inter-vehicle distance value between a forward vehicle and the vehicle 20 which is currently driving.

The digital cockpit system 100 may collect driver information from a user terminal 10 over a wired/wireless network. The driver information may include, for example, age, name, sex, driving history, and accident history of a driver, an ID/password set by the driver, and pieces of information associated with the kind of a vehicle. The driver information may further include previous driving path information. The previous driving path information may be obtained from a navigation system.

An application for providing a service according to an embodiment of the present invention may be installed in the user terminal 10, and the driver may input the driver information to the user terminal 10 through an input means included in the user terminal 10, based on a request of the installed application. The driver information may be used as registration information for registering the user terminal 10 in the cloud server 300.

The user terminal 10 may include at least one of a smartphone, a tablet personal computer (PC), a mobile phone, a video phone, an e-book reader, a desktop PC, a laptop PC, a netbook PC, a personal digital assistant (PDA), a portable multimedia player (PMP), an MP3 player, a mobile medical device, a camera, and a wearable device (e.g., a head-mounted device (HMD), electronic clothes, electronic braces, an electronic necklace, an electronic appcessory, an electronic tattoo, or a smart watch).

The digital cockpit system 100 may generate personal vehicle information which includes the driver information collected from the user terminal 10 and pieces of driving information about the vehicle 20 collected from the sensor group 120.

When the vehicle 20 parks or stops, the digital cockpit system 100 may transmit the personal vehicle information to the cloud server 300. Also, the digital cockpit system 100 may transmit the personal vehicle information, which is accumulated whenever the vehicle 20 parks or stops, to the cloud server 300. The digital cockpit system 100 may transmit the personal vehicle information to the cloud server 300 through the user terminal 10 or a communication infrastructure around the vehicle 20.

The cloud server 300 may analyze the personal vehicle information collected from the digital cockpit system 100 to determine the personal driving tendency of the driver, generate a driver-customized parameter optimized for the determined personal driving tendency, and transmit the determined personal driving tendency to the digital cockpit system 100.

The personal driving tendency may include “cautious” style, “sports” style, “economic driving” style, or “defensive driving” style. A machine learning model may be used for determining the personal driving tendency and generating the driver-customized parameter optimized for the determined personal driving tendency.

The driver-customized parameter may be information which is used for customizing driving assistance information, obtained from the driver assistance system 130, for the determined personal driving tendency.

The digital cockpit system 100 may apply the driver-customized parameter, received from the cloud server 300, to an output policy corresponding to the driving assistance information received from the driver assistance system 130.

The output policy may be a policy which determines a type of information, into which the digital cockpit system 100 converts the driving assistance information, and whether to provide converted information by using an HMI of the digital cockpit system 100.

Moreover, the output policy may be a policy which determines whether to output the driving assistance information, based on the driver-customized parameter. For example, the digital cockpit system 100 may ignore or limit various warning commands included in the driving assistance information, based on the driver-customized parameter.

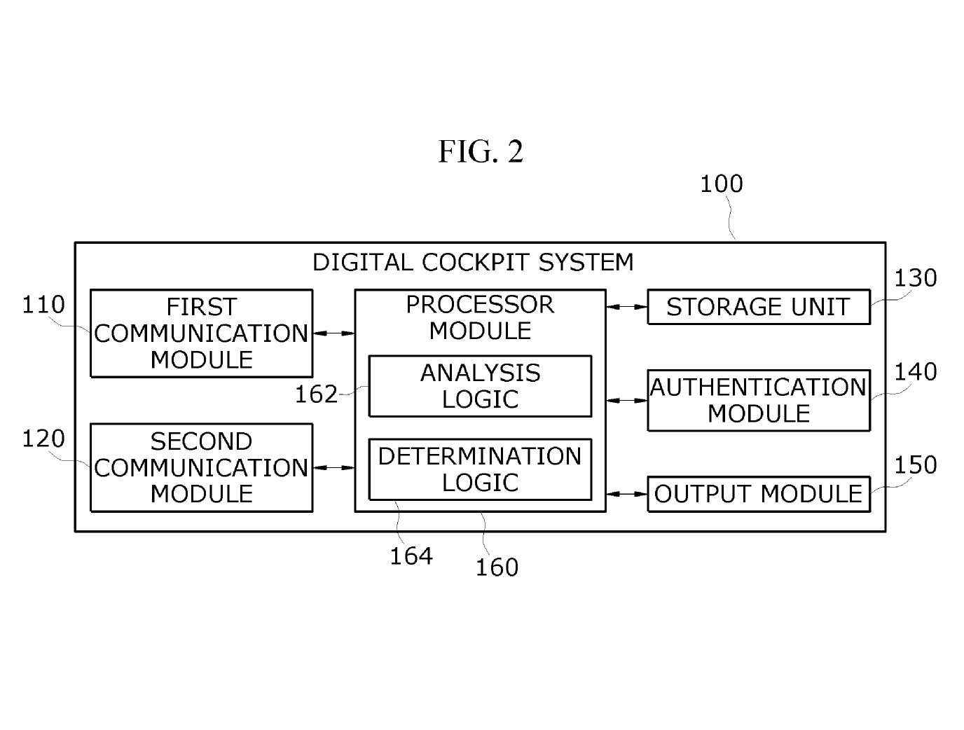

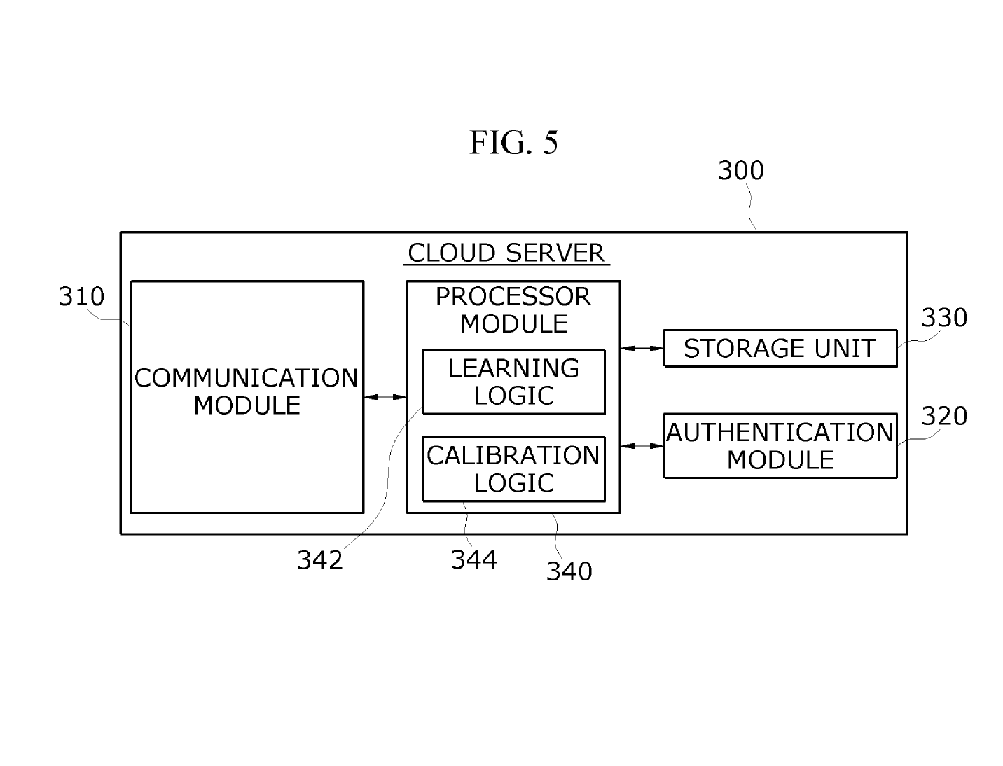

Hereinafter, the digital cockpit system 100 and the cloud server 300 will be described in more detail with reference to FIGS. 2 and 5.

FIG. 2 is a block diagram schematically illustrating an internal configuration of a digital cockpit system 100 according to an embodiment of the present invention.

Referring to FIG. 2, the digital cockpit system 100 may include a first communication module 110, a second communication module 120, a storage unit 130, an authentication module 140, an output module 150, and a processor module 160.

The first communication module 110 may perform communication with the sensor group 120 and the driver assistance system 130 over a vehicle's internal communication network. The vehicle's internal communication network may include, for example, controller area network (CAN), local interconnect network (LIN), media oriented systems transport (MOST), and X-by-wire (Flexray).

The second communication module 120 may perform wired/wireless communication with the user terminal 10 and the cloud server 300. The wireless communication may include, for example, cellular communication, short-distance wireless communication, or global navigation satellite system (GNSS) communication.

The cellular communication may include, for example, long-term evolution (LTE), LTE Advance (LTE-A), code division multiple access (CDMA), wideband CDMA (WCDMA), universal mobile telecommunications system (UMTS), wireless broadband (WiBro), or global system for mobile communications (GSM).

The short-distance wireless communication may include, for example, wireless fidelity (WiFi), WiFi Direct, light fidelity (LiFi), Bluetooth, Bluetooth low energy (BLE), Zigbee, near field communication (NFC), magnetic secure transmission, radio frequency (RF), or body area network (BAN). The wired communication may include, for example, universal serial bus (USB) communication or RS-232C communication.

The storage unit 130 may store driver information received through the second communication module 120 according to control by the processor module 160. By storing the driver information in the storage unit 130, the digital cockpit system 100 may register the user terminal 10 or a driver possessing the user terminal 10.

Moreover, the storage unit 130 may store pieces of driving information received from the sensor group 120 through the first communication module 120 and may store driving assistance information received from the driver assistance system 130.

The storage unit 130 may include a volatile memory or a non-volatile memory. Examples of the volatile memory may include random access memory (RAM) (for example, dynamic random access memory (DRAM), static random access memory (SRAM), or synchronous DRAM (SDRAM)). Examples of the non-volatile memory may include one time programmable ROM (OTPROM), programmable read only memory (PROM), erasable programmable read only memory (EPROM), electrical erasable programmable read only memory (EEPROM), mask ROM, flash ROM, flash memory, hard drive, and solid state drive (SSD).

The authentication module 140 may perform authentication on the user terminal 10 or the driver possessing the user terminal 10 by using the driver information stored in the storage unit 130. Also, the authentication module 140 may perform authentication on the digital cockpit system 100.

Authentication by the authentication module 140 may also be performed by the processor module 160. In this case, the processor module 160 may include an authentication logic for performing an authentication operation.

The output module 150 may convert driving information, infortainment information, and driving assistance information into various pieces of information having a form recognizable by persons and may output converted information. The output module 150 may include a display device such as a liquid crystal display (LCD) or an organic light emitting display (OLED), a speaker, an audio output device, a vibration motor, a haptic feedback device. The output module 150 may output the driving assistance information received from the driver assistance system according to control by the processor module 160, based on an HMI-based output policy.

The processor module 160 may control and manage operations of the peripheral elements 110, 120, 130, 140, and 150. The processor module 160 may include one or more of a central processing unit (CPU), an application processor, a graphic processing unit (GPU), a camera image signal processor, and a communication processor (CP).

The processor module 160 may be implemented as a system on chip (SoS) or a system in package (SiP). The processor module 160 may drive, for example, an operating system or an application program to perform processing and an arithmetic operation on various pieces of data.

The processor module 160 may load commands, data, or information, received from the elements 110 and 120, into a volatile memory, process the loaded commands, data, or information, and store result data in a non-volatile memory.

In order to receive a driver-customized parameter from the cloud server 300, the processor module 160 may generate personal vehicle information including pieces of driving information and driver information stored in the storage unit 130 and may control the second communication module 120 so as to transmit the personal vehicle information to the cloud server 300. At this time, the processor module 160 may transmit the personal vehicle information to the cloud server 300 at a time when the vehicle 20 parks or stops. That is, the processor module 160 may transmit the personal vehicle information to the cloud server 300 until immediately before the vehicle 20 parks or stops. Driving information included in the personal driving information may be newly accumulated whenever the vehicle 20 drives.

The processor module 160 may transmit the personal vehicle information including the newly accumulated driving information to the cloud server 300 whenever the vehicle parks or stops. Accordingly, the cloud server 300 may reflect driving information accumulated whenever the vehicle drives, thereby continually updating the driver-customized parameter.

The parking or stop of the vehicle may be determined based on an on/off status of an ignition signal which varies based on a variation of a start key manipulation status of the driver. That is, when the ignition signal having the off status indicating the parking or stop of the vehicle is received from an engine control unit (ECU) (not shown) associated with the start of the vehicle, the processor module 160 may control the second communication module 120 so as to transmit the personal vehicle information to the cloud server 300.

The processor module 160 may determine whether to output safety driving information received from the driver assistance system 130, based on the driver-customized parameter received from the cloud server 300.

To this end, the processor module 160 may include an analysis logic 162 and a determination logic 164. The analysis logic 162 may analyze the driving assistance information to construe a real status value representing a real driving status of the vehicle. The determination logic 164 may compare the real status value with a customized status value defined in the driver-customized parameter and may control the output module 150 so as to limit an output of the driving assistance information, based on a result of the comparison.

For example, when the real status value is included in a range which is defined based on the customized status value and a reference status value set as an output condition of the driving assistance information in the driver assistance system 130, the determination logic 164 may control an output of the output module 150 so as not to output the driver assistance information.

The real status value, as described above, may be a value included in the driver assistance information provided from the driver assistance system 130, and as described above, the real status value may be a real distance value D_{REAL} between a lane mark line L provided by the LDWS 132 and the vehicle 120 which is currently driving.

The reference status value may be a value which is set as a lane departure warning condition in the LDWS 132 and may be the real distance value D_{REAL} between the lane mark line L provided by the LDWS 132 and the vehicle 120 which is currently driving. When the real distance value D_{REAL} between the lane mark line L provided by the LDWS 132 and the vehicle 120 which is currently driving is less than a reference distance value DREF, the LDWS 132 may be set to warn against lane departure.

The customized status value may be a value representing a lane departure warning condition and may be a customized distance value D_{C} optimized for a personal driving tendency. At a time t1, when the real distance value D_{REAL} is greater than the reference distance value D_{REF}, the determination logic 164 may control the output module 150 so as not to output lane departure warning information (driving assistance information). At a time t2, when the real distance value D_{REAL} is less than the reference distance value DREF, the lane departure warning condition set by the LDWS 132 may be satisfied, and thus, the determination logic 164 may control the output module 150 so as to output the lane departure warning information (the driving assistance information). However, in an embodiment of the present invention, an output policy may be changed to output the lane departure warning information (the driving assistance information) only when the vehicle 120 which is currently driving enters a position within the customized distance value D_{C} optimized for the personal driving tendency. Therefore, the determination logic 164 may control the output module 150 so as to output the lane departure warning information (the driving assistance information) at a time t3 instead of the time t2.

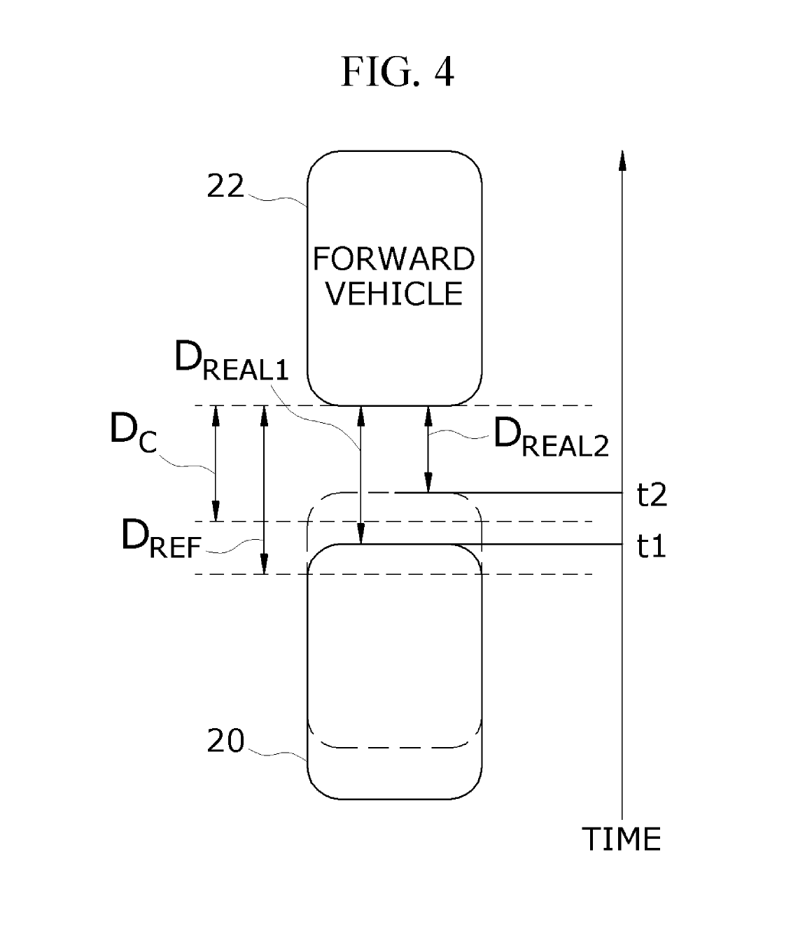

Similarly, the determination logic 164 may change an output policy corresponding to the forward vehicle collision warning information (the driving assistance information) so as to be optimized for the personal driving tendency. For example, as illustrated in FIG. 4, when a reference status value set as a forward collision warning condition in the FCWS 134 is a reference distance value D_{REF} between a forward vehicle 22 and the vehicle 120 which is currently driving, at the time t1, a real distance value D_{REAL1} (a real status value) between the forward vehicle 22 and the vehicle 120 which is currently driving is less than the reference distance value D_{REF}, the determination logic 164 may control the output module 150 so as to output the forward collision warning information (the driver assistance information). However, in an embodiment of the present invention, an output policy may be changed to output the lane departure warning information (the driving assistance information) only when the vehicle 120 which is currently driving enters a position within the customized inter-vehicle distance value D_{C} optimized for the personal driving tendency. Therefore, the determination logic 164 may control the output module 150 so as to output the forward collision warning information (the driving assistance information) at the time t2 when a real distance value D_{REAL2} (a real status value) between the forward vehicle 22 and the vehicle 120 which is currently driving is less than the customized inter-vehicle distance value D_{C} (a customized status value).

FIG. 5 is a block diagram schematically illustrating an internal configuration of a cloud server 300 according to an embodiment of the present invention.

Referring to FIG. 5, the cloud server 300 may include a communication module 310, an authentication module 320, a cloud storage unit 330, and a processor module 340.

The communication module 310 may perform wired/wireless communication with the digital cockpit system 100 in a vehicle 20. The communication module 310 may receive personal vehicle information from the digital cockpit system 100 according to control by the processor module 340. The communication module 310 may transmit a driver-customized parameter, generated or updated by the processor module 340, to the digital cockpit system 100. At this time, the communication module 310 may transmit the driver-customized parameter to the digital cockpit system 100 equipped in the vehicle 20 or another digital cockpit system equipped in a vehicle which differs from the kind of the vehicle 20. Accordingly, regardless of the kinds of vehicles, each of drivers of all vehicles equipped with the digital cockpit system 100 according to an embodiment of the present invention may be provided with a driver-customized parameter optimized for its driving tendency.

The authentication module 320 may perform authentication on the user terminal 10 and a driver or the digital cockpit system 100 in response to an authentication request message received through the communication module 310 from the digital cockpit system 100.

The authentication request message may be generated by the user terminal 100, and the digital cockpit system 100 may transfer the authentication request message, generated by the user terminal 100, to the authentication module 320.

The authentication module 320 may compare an ID and a password of a driver registered in the cloud storage unit 330 with an ID and a password of a driver included in the authentication request message, and when a match therebetween, the authentication module 320 may transmit a response message representing authentication success to the digital cockpit system 100.

When the response message representing authentication success is received, the digital cockpit system 100 may start to transmit collected personal vehicle information. When authentication fails or when the vehicle parks or stops, the personal vehicle information may not be transmitted. Therefore, personal information about a driver included in the personal vehicle information may be prevented from being leaked to the outside without approval of the driver. The authentication module 320 may be embedded into the processor module 340 as a logic type.

Personal vehicle information received through the communication module 310 may be stored in the cloud storage unit 330. Also, a driver-customized parameter generated or updated by the processor module 340 may be stored in the cloud storage unit 330. Also, big data collected by the processor module 340 through the communication module 310 from an external server may be stored in the cloud storage unit 330. The big data may include massive vehicle information published by a public organization and personal vehicle information distributed by a digital cockpit system equipped in another vehicle of another driver. In this case, the personal vehicle information distributed by the digital cockpit system equipped in the other vehicle may be information which is allowed by the other driver to be externally published.

The processor module 340 may collect personal vehicle information about a personal driver from the digital cockpit system 100 through the communication module 310 and may store the collected personal vehicle information in the cloud storage unit 330, in order to customize driving assistance information, provided from the driver assistance system 130, for a personal driving tendency of the personal driver.

The processor module 340 may build a machine learning model which is pre-learned to generate a driver-customized parameter, based on the collected personal vehicle information.

The processor module 340 may determine a personal driving tendency based on the collected personal vehicle information by using the machine learning model and may generate the driver-customized parameter based on the determined personal driving tendency.

The processor module 340 may include a learning logic 342 and a calibration logic 342, for generating the driver-customized parameter.

The learning logic 342 may perform machine learning on the basis of published vehicle information stored in the cloud storage unit 330 to generate a machine learning model. The machine learning may use a time-series model-based technique or a deep learning-based technique.

Examples of the time-series model-based technique may include an autoregressive integrated moving average (ARIMA) technique, where a variation of an action with respect to a time is described as stochastic, and a multi-layer perceptron (MLP) technique using a nonparametric regression method.

Moreover, examples of the deep learning-based technique may include a stacked auto encoder (SAE) technique where input data and output data become similar through dimension reduction, a recurrent neural networks (RNNs) technique which is a neural network algorithm for processing sequential information, and a long short term memory (LSTM) technique suitable for long time dependency learning.

A machine learning model generated from a result obtained by performing the machine learning may include a classification model, which classifies the driving tendency based on the published vehicle information, and a prediction model which predicts a driver-customized parameter mapped to the driving tendency determined based on the classification model.

The learning logic 342 may again perform the machine learning on the basis of the personal vehicle information to update the classification model and the prediction model. The learning logic 342 may continually update the classification model and the prediction model so as to reflect a personal driving tendency based on the personal vehicle information whenever new personal vehicle information is received.

As described above, as a vehicle drives and stops repeatedly, a machine learning model may be optimized for a personal driving tendency on the basis of newly received personal vehicle information, and a driver-customized parameter may be completely customized for a personal driving tendency.

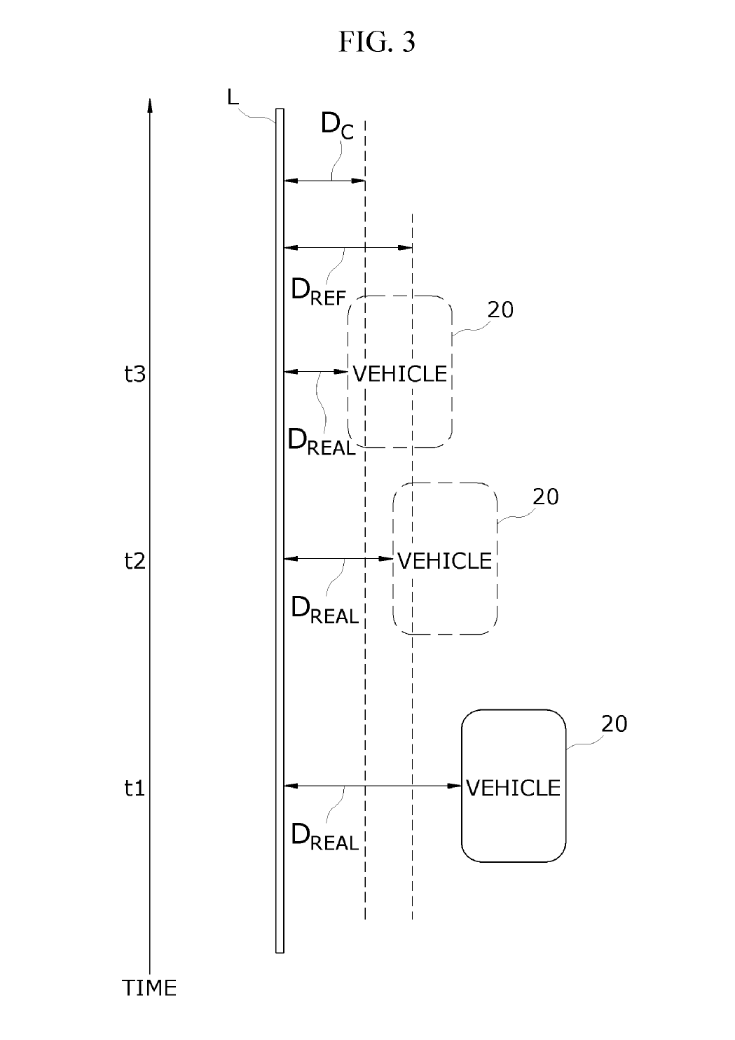

The calibration logic 344 may perform an operation of calibrating a driver-customized parameter generated or updated by the learning logic 342, based on the kind of the vehicle. Vehicles may have different sizes (lengths, widths, and heights) depending on the kinds of the vehicles. In this case, a customized status value D_{C} (for example, a customized distance value D_{C} illustrated in FIG. 3 and a customized inter-vehicle distance value D_{C} illustrated in FIG. 4) defined in the driver-customized parameter may be calibrated based on a vehicle size.

A calibration table may be used for calibrating the generated or updated driver-customized parameter. The calibration table may be a table where a calibration value applied to a driver-customized parameter (a customized status value) is pre-defined based on the kind of a vehicle. The calibration table may be stored in the cloud storage unit 330, and thus, the processor module 340 may use the calibration table depending on the case.

The processor module 340 may transmit the calibrated driver-customized parameter to the digital cockpit system 100 so as to apply the calibrated driver-customized parameter to an output policy corresponding to the driving assistance information.

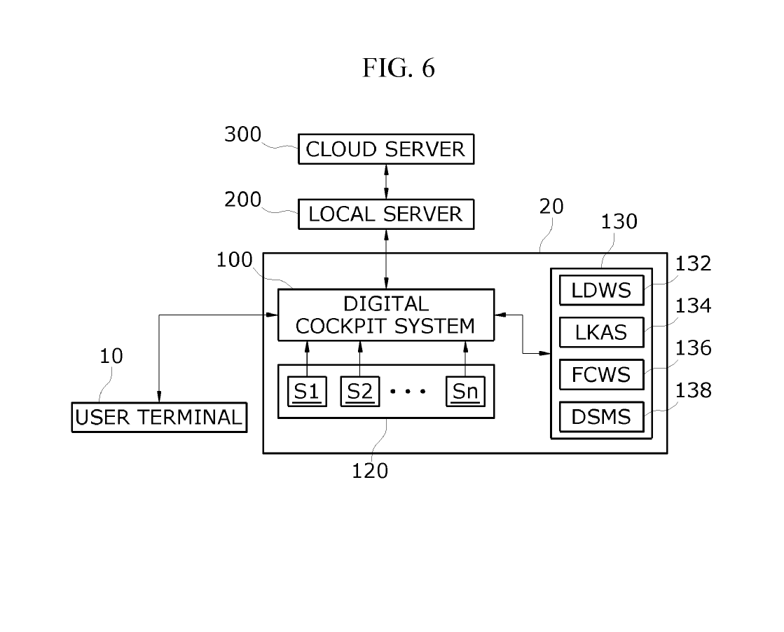

FIG. 6 is a block diagram illustrating an operating system according to another embodiment of the present invention.

Referring to FIG. 6, the operating system according to another embodiment of the present invention may include a local server 200 which provides an interface between a digital cockpit system 100 and a cloud server 300, and thus, there is a difference between the operating system illustrated in FIG. 1 and the operating system according to the present embodiment.

The local server 200 may be an access point (AP), a relay device, a router, a gateway, or a hub. The local server 200 may be configured to have some of functions of the cloud server 300. For example, the local server 200 may be configured to have an authentication function and a driver-customized parameter calibrating function among the functions of the cloud server 300. In this case, in FIG. 5, the calibration logic 344 and the authentication module 320 may be omitted. Therefore, the processing burden and establishment cost of the cloud server 300 may be reduced.

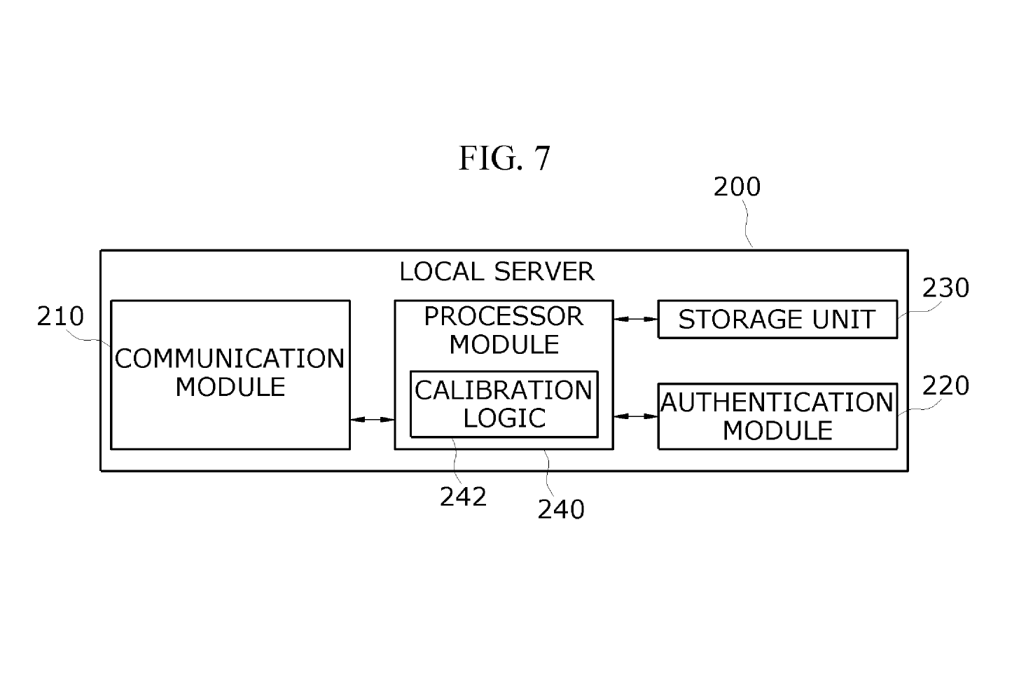

FIG. 7 is a block diagram schematically illustrating an internal configuration of a local server 200 according to an embodiment of the present invention.

Referring to FIG. 7, the local server 200 may include a communication module 210, an authentication module 220, a local storage unit 230, and a processor module 240.

The communication module 210 may perform wired/wireless communication with each of a digital cockpit system 100 and a cloud server 300 according to control by the processor module 240. The communication module 210 may transmit personal vehicle information, received from the digital cockpit system 100, to the cloud server 300 and may transmit a driver-customized parameter, received from the cloud server 300, to the digital cockpit system 100.

The communication module 210 may transfer an authentication request message, received from the digital cockpit system 100, to the authentication module 220 according to control by the processor module 240. In this case, the communication module 210 may directly receive the authentication request message from the user terminal 10.

The authentication module 220 may perform authentication on the user terminal 10. When authentication succeeds, the local server 200 may transmit the personal vehicle information, received from the digital cockpit system 100, to the cloud server 300.

The processor module 240 may store the personal vehicle information, which is to be transmitted to the cloud server 300, in the local storage unit 230, and then, when transmission of the personal vehicle information is completed, the processor module 240 may delete the personal vehicle information stored in the local storage unit 230.

Similarly, the processor module 240 may store a driver-customized parameter, which is to be transmitted to the digital cockpit system 100, in the local storage unit 230, and then, when transmission of the driver-customized parameter is completed, the processor module 240 may delete the driver-customized parameter stored in the local storage unit 230.

The local server 200 may be a low performance device which does not include a sufficient memory resource such as a storage space in comparison with the cloud server 300. Therefore, the local server 200 may delete transmission-completed data in the local storage unit 230.

The processor module 240 may include a calibration logic 242. The calibration logic 242 may perform an operation of calibrating the driver-customized parameter received from the cloud server 300, based on the kind of the vehicle.

When the local server 200 calibrates the driver-customized parameter, the cloud server 300 may delete a function of calibrating the driver-customized parameter. Accordingly, a load applied to the cloud server 300 may be reduced.

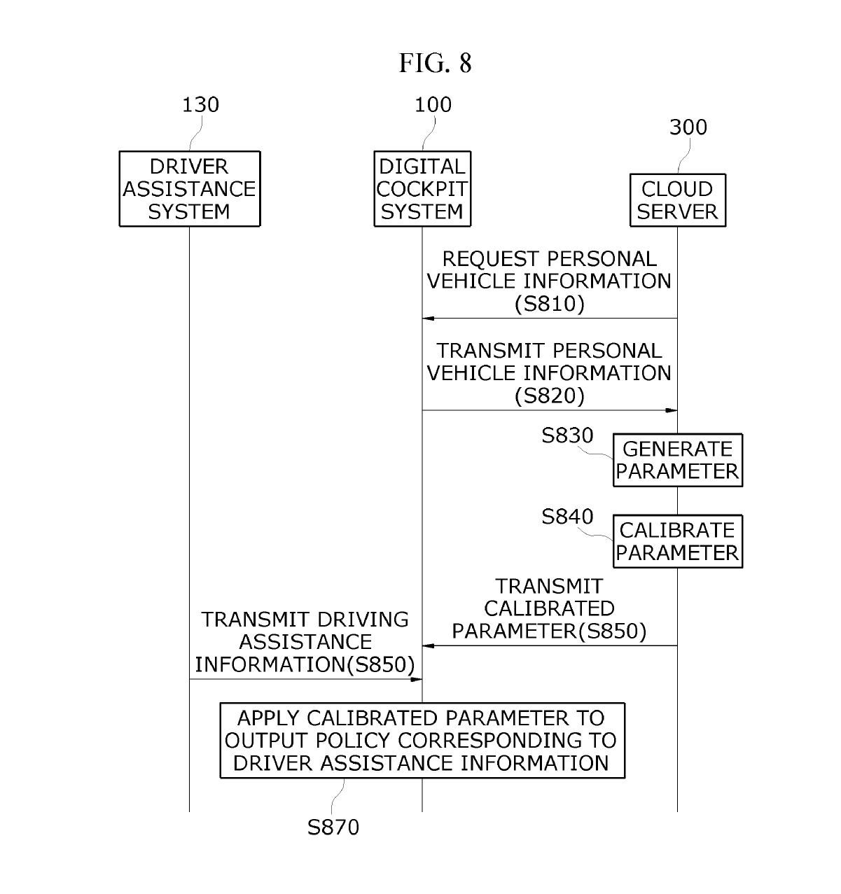

FIG. 8 is a flowchart illustrating an operating method of an operating system according to an embodiment of the present invention.

In the operating method according to an embodiment, it may be assumed that a cloud server 300 performs authentication on a user terminal 10 and/or a digital cockpit system 100. Also, for conciseness of description, descriptions overlapping descriptions given above with reference to FIGS. 1 to 7 will be briefly described or omitted.

Referring to FIG. 8, when it is checked by the cloud server 300 that the authentication on the user terminal 10 and/or the digital cockpit system 100 succeeds, the cloud server 300 may transmit a request message, requesting personal vehicle information, to the digital cockpit system 100 in step S810.

Subsequently, in step S820, in response to the request message, the digital cockpit system 100 may generate personal vehicle information including driver information collected from the user terminal 10 and pieces of driving information collected from the sensor group 120 of a vehicle and may transmit the generated personal vehicle information to the cloud server 300.

Subsequently, in step S830, by using a previously built machine learning model, the cloud server 300 may determine a personal driving tendency corresponding to the personal vehicle information received from the digital cockpit system 100 and may generate a driver-customized parameter based on the determined personal driving tendency.

Subsequently, in step S840, the cloud server 300 may calibrate the generated driver-customized parameter, based on the kind of the vehicle.

Subsequently, in step S850, the cloud server 300 may transmit the calibrated driver-customized parameter to the digital cockpit system 100. The driver-customized parameter may define a customized status value. For example, the customized status value may be defined as a value obtained by optimizing a reference status value, representing a warning condition set by the driver assistance system 130, for the personal driving tendency so as to warn against vehicle departure or forward collision. The customized status value may be a customized distance value between a lane mark line and the vehicle or a customized inter-vehicle distance value between the vehicle and a forward vehicle.

Subsequently, in step S860, the digital cockpit system 100 may transmit driving assistance information to the driver assistance system 130. The driving assistance information may include an ID representing the kind of a driving assistance service and a real status value representing a driving status of the vehicle. When the driving assistance information is vehicle departure warning information, the real status value may be a real distance value between a lane mark line and a vehicle which is driving. When the driving assistance information is forward collision warning information, the real status value may be a real distance value between a forward vehicle which is driving and a vehicle which is driving.

Subsequently, in step S870, the digital cockpit system 100 may apply the calibrated driver-customized parameter, received from the cloud server 300, to an output policy corresponding to the driving assistance information received from the driver assistance system 130. For example, the digital cockpit system 100 may compare a customized status value defined in the driver-customized parameter and a real status value included in the driving assistance information and may determine whether to provide a driving assistance service classified by an ID included in the driving assistance information, based on a result of the comparison.

In a case where the driving assistance service is a vehicle departure warning service, when a real distance value D_{REAL} included in the vehicle departure warning information is less than a reference distance value D_{REF} defined as a warning condition in the vehicle departure warning service but is greater than a customized distance value D_{C}, the digital cockpit system 100 may not generate vehicle departure information. That is, only when the real distance value D_{REAL} included in the vehicle departure warning information is less than customized distance value D_{C}, the digital cockpit system 100 may generate the vehicle departure information.

As described above, according to an embodiment of the present invention, various driving assistance services (warning services) provided by the driver assistance system may be customized for a personal driving tendency without changing a design of the driver assistance system.

A process (S840), performed by the cloud server, of calibrating the driver-customized parameter according to the kind of the vehicle may be omitted for decreasing the processing burden of the cloud server 300.

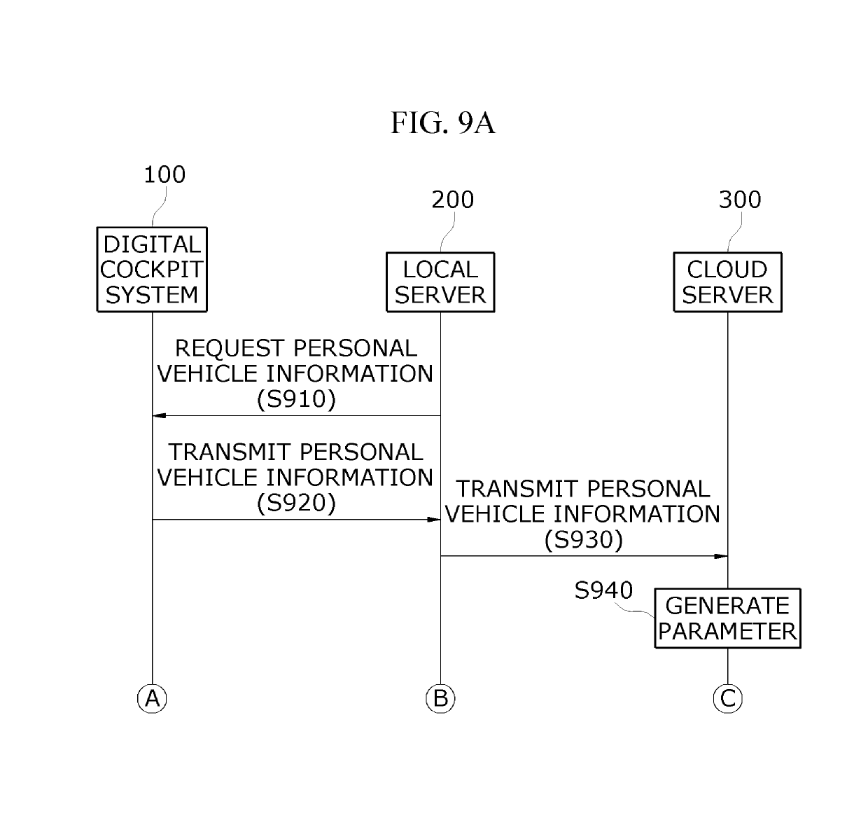

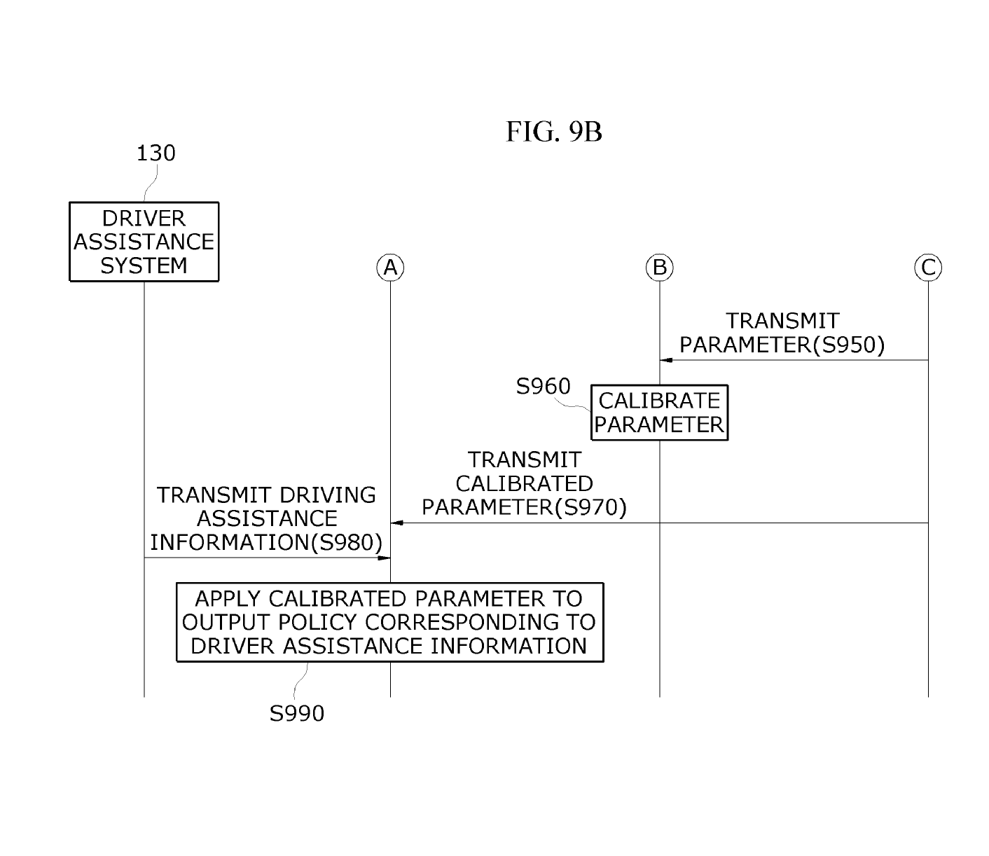

FIGS. 9A and 9B are flowchart illustrating an operating method of an operating system according to another embodiment of the present invention.

In the present embodiment, a local server 200 may be disposed between a digital cockpit system 100 and a cloud server 300, and thus, the operating method according to another embodiment of the present invention has a difference with the operating method of FIG. 8.

In the operating method according to another embodiment, it may be assumed that the local server 200 performs authentication on the user terminal 10 and/or the digital cockpit system 100. Also, for conciseness of description, descriptions overlapping descriptions given above with reference to FIGS. 1 to 8 will be briefly described or omitted.

When it is checked by the local server 200 that the authentication on the user terminal 10 and/or the digital cockpit system 100 succeeds, the local server 200 may transmit a request message, requesting personal vehicle information, to the digital cockpit system 100 in step S910.

Subsequently, in step S920, the digital cockpit system 100 may generate personal vehicle information including driver information collected from the user terminal 10 and pieces of driving information collected from the sensor group 120 and may transmit the generated personal vehicle information to the local server 200.

Subsequently, in step S930, the local server 200 may transmit the personal vehicle information, received from the digital cockpit system 100, to the cloud server 300. At this time, when the transmission of the personal vehicle information is completed, the local server 200 may delete the personal vehicle information stored in the local storage unit 230, for transmitting the personal vehicle information.

Subsequently, in step S940, by using a previously built machine learning model, the cloud server 300 may determine a personal driving tendency corresponding to the personal vehicle information received from the digital cockpit system 100 and may generate a driver-customized parameter based on the determined personal driving tendency.

Subsequently, in step S950, the cloud server 300 may transmit the generated driver-customized parameter to the local server 200.

Subsequently, in step S960, the local server 200 may transmit the driver-customized parameter received from the cloud server 300, based on the kind of the vehicle.

Subsequently, in step S970, the local server 200 may transmit the calibrated driver-customized parameter to the digital cockpit system 100.

Subsequently, in step S980, the digital cockpit system 100 may transmit driving assistance information to the driver assistance system 130.

Subsequently, in step S990, the digital cockpit system 100 may apply the calibrated driver-customized parameter, received from the cloud server 300, to an output policy corresponding to the driving assistance information received from the driver assistance system 130. For example, the digital cockpit system 100 may compare a customized status value defined in the driver-customized parameter and a real status value included in the driving assistance information and may determine whether to provide a driving assistance service classified by an ID included in the driving assistance information, based on a result of the comparison.

In a case where the driving assistance service is a vehicle departure warning service, when a real distance value D_{REAL} included in the vehicle departure warning information is less than a reference distance value D_{REF} defined as a warning condition in the vehicle departure warning service but is greater than a customized distance value D_{C}, the digital cockpit system 100 may not generate vehicle departure information. That is, only when the real distance value D_{REAL} included in the vehicle departure warning information is less than customized distance value D_{C}, the digital cockpit system 100 may generate the vehicle departure information.

As described above, according to an embodiment of the present invention, various driving assistance services (warning services) provided by the driver assistance system may be customized for a personal driving tendency without changing a design of the driver assistance system.

As described above, according to the embodiments of the present invention, the digital cockpit system cooperating with the cloud server may intelligently update a service provided by a vehicle's internal system by using the cloud server so as to customize the service, provided by the vehicle's internal system, for the driving tendency of a driver, and thus, the satisfaction of the driver in the vehicle's internal system may be enhanced even without user's directly updating a function of the vehicle's internal system.

Moreover, the digital cockpit system according to the embodiments of the present invention may accumulate information which is collected whenever a vehicle parks or stops and may continuously update a service provided by the vehicle's internal system, based on the accumulated information, thereby providing various customer-customized service by using the digital cockpit system according to the embodiments of the present invention.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A cloud server for communicating with a vehicle including a driver assistance system for providing driving assistance information associated with safety of a driver and a digital cockpit system for providing the driving assistance information in cooperation with the driver assistance system, the cloud server comprising:
a processor module; and
a communication module configured to communicate with the digital cockpit system,
wherein, in order to customize the driving assistance information for a personal driving tendency of a personal driver, the processor module collects personal vehicle information about the personal driver from the digital cockpit system through the communication module, determines the personal driving tendency based on the collected personal vehicle information by using a previously built machine learning model, generates a driver-customized parameter based on the determined personal driving tendency, and transmits the driver-customized parameter to the digital cockpit system through the communication module so that the digital cockpit system applies the driver-customized parameter to an output policy corresponding to the driving assistance information.

2. The cloud server of claim 1, wherein the processor module performs machine learning on basis of published vehicle information collected from an external server to generate the machine learning model which comprises a classification model for classifying a driving tendency based on the published vehicle information and a prediction model for predicting a driver-customized parameter mapped to a driving tendency determined based on the classification model.

3. The cloud server of claim 2, wherein the processor module again performs the machine learning on basis of the personal vehicle information to update the classification model and the prediction model and continually updates the classification model and the prediction model whenever new personal vehicle information is received through the communication module.

4. The cloud server of claim 1, further comprising a cloud storage unit configured to store the driver-customized parameter,
wherein the communication module transmits the driver-customized parameter, stored in the cloud storage unit, to the digital cockpit system equipped in the vehicle or another digital cockpit system equipped in another vehicle which differs from a kind of the vehicle, based on control by the processor module.

5. The cloud server of claim 1, wherein the processor module generates the driver-customized parameter configured to be applied to the driving assistance information comprising at least one of lane departure warning information and forward vehicle collision warning information.

6. The cloud server of claim 1, wherein the processor module generates the driver-customized parameter which comprises a parameter indicating a customized distance value between a lane mark line and a driving vehicle for customizing a lane departure warning condition, set in the driver assistance system, for the personal driving tendency and a customized inter-vehicle distance value between the vehicle and a forward vehicle for customizing a forward vehicle collision warning condition, set in the driver assistance system, for the personal driving tendency.

7. The cloud server of claim 1, wherein the processor module calibrates the generated driver-customized parameter, based on a kind of the vehicle and transmits the calibrated driver-customized parameter to the digital cockpit system through the communication module.

8. An operating system comprising:
a digital cockpit system configured to receive driving assistance information associated with safety and convenience of a personal driver from a driver assistance system over an internal communication network of a vehicle, output the driving assistance information according to a human-machine interface (HMI)-based output policy (hereinafter referred to as an HMI output policy), and collect personal vehicle information about the personal driver from a plurality of vehicle sensors over the internal communication network of the vehicle; and
a cloud server configured to collect the personal vehicle information from the digital cockpit system over a wireless network for customizing the driving assistance information for a personal driving tendency of the personal driver, predict a driver-customized parameter based on the collected personal vehicle information by using a previously built machine learning model, and transmit the driver-customized parameter to the digital cockpit system over the wireless network,
wherein the digital cockpit system applies the driver-customized parameter to the HMI output policy.

9. The operating system of claim 8, wherein
the digital cockpit system comprises:
a processor module;
a communication module configured to communicate with the cloud server over the wireless network; and
an output module configured to output the driving assistance information according to the HMI output policy, and
the processor module applies the driver-customized parameter to the HMI output policy which determines whether to output the safety driving information.

10. The operating system of claim 8, wherein
the digital cockpit system comprises:
a processor module;
a communication module configured to communicate with the cloud server over the wireless network; and
an output module configured to output the driving assistance information according to the HMI output policy, and
the processor module analyzes the driving assistance information to construe a real status value representing a real driving status of the vehicle, compares the real status value with a customized status value defined in the driver-customized parameter, and determines whether to output the driving assistance information through the output module, based on a result obtained by comparing the real status value with the customized status value.

11. The operating system of claim 10, wherein, when the real status value is within a range defined by the customized status value and a reference status value which is set for outputting the driving assistance information in the driver assistance system, the processor module controls the output module not to output the driving assistance information.

12. The operating system of claim 8, wherein
the digital cockpit system comprises:
a processor module;
a communication module configured to communicate with the cloud server over the wireless network;
an output module configured to output the driving assistance information according to the HMI output policy; and
a storage unit configured to store the collected personal vehicle information, and
the processor module controls the communication module to transmit the personal vehicle information, stored in the storage unit, to the cloud server at a time when the vehicle parks or stops.

13. The operating system of claim 8, further comprising a local server configured to provide an interface between the digital cloud system and the cloud server,
wherein
the local server comprises:
a processor module; and
a communication module configured to transmit the personal vehicle information, collected from the digital cloud system, to the cloud server, and
the processor module calibrates the driver-customized parameter received through the communication module from the cloud server, based on a kind of the vehicle and transmits the calibrated driver-customized parameter to the digital cloud system through the communication module.

14. The operating system of claim 13, wherein
the local server further comprises an authentication module, and
the authentication module performs authentication on the personal driver by using driver information about the personal driver received through the communication module from the digital cloud system.

15. An operating method of an operating system including a cloud server and a digital cockpit system connected to a driver assistance system, the operating method comprising:
collecting, by the digital cockpit system, personal vehicle information including pieces of driving information received from sensors of a vehicle;
transmitting, by the cloud server, a request message requesting the personal vehicle information to the digital cockpit system;
transmitting, by the digital cockpit system, the personal vehicle information to the cloud server in response to the request message;
determining, by the cloud server, a personal driving tendency corresponding to the personal vehicle information by using a machine learning model, generating a driver-customized parameter based on the determined personal driving tendency, and transmitting the driver-customized parameter to the digital cockpit system; and
applying, by the digital cockpit system, the driver-customized parameter received from the cloud server to an output policy corresponding to driving assistance information received from the driver assistance system.

16. The operating method of claim 15, wherein the transmitting of the driver-customized parameter comprises:
performing machine learning on basis of published vehicle information collected from an external server to generate the machine learning model which comprises a classification model for classifying a driving tendency based on the published vehicle information and a prediction model for predicting a driver-customized parameter mapped to a driving tendency determined based on the classification model; and
again performing the machine learning on basis of the personal vehicle information to update the classification model and the prediction model.

17. The operating method of claim 15, wherein the transmitting of the driver-customized parameter comprises transmitting the driver-customized parameter to the digital cockpit system equipped in a first vehicle or another digital cockpit system equipped in a second vehicle which differs from a kind of the first vehicle.

18. The operating method of claim 15, wherein the applying comprises:
comparing a real status value included in the driving assistance information with a customized status value defined in the driver-customized parameter; and
determining whether to output the driving assistance information, based on a result obtained by comparing the real status value with the customized status value.

19. The operating method of claim 18, wherein
the customized status value is a value customized for the personal driving tendency and is a distance value (a customized distance value) between a lane mark line and a vehicle, and the real status value is a distance value (a real distance value) between the lane mark line and a vehicle which is driving, and
the determining comprises:
when the real distance value is equal to or more than the customized distance value, stopping an output of the driving assistance information; and
when the real distance value is less than the customized distance value, outputting the driving assistance information.

20. The operating method of claim 18, wherein
the customized status value is a value customized for the personal driving tendency and is an inter-vehicle distance value (a customized inter-vehicle distance value) between a forward vehicle and a vehicle of a driver, and the real status value is an inter-vehicle distance value between the forward vehicle which is really driving and the vehicle, which is really driving, of the driver, and
the determining comprises:
when the real distance value is equal to or more than the customized distance value, stopping an output of the driving assistance information; and
when the real distance value is less than the customized distance value, outputting the driving assistance information.
